(19) United States
(12) Patent Application Publication
(10) Pub. No.: US 2021/0371989 A1
(43) Pub. Date: Dec. 2, 2021

(54) SYSTEMS AND METHODS FOR CONTROLLING CHLORATE PRODUCTION IN ELECTROLYTIC CELLS

(71) Applicant: DE NORA HOLDINGS US, INC., Concord, OH (US)

(72) Inventors: Andrew K. BOAL, Longmont, CO (US); Christopher ZALITIS, Reading (GB); Nkoy Jean-Paul MONALI, Sugar Land, TX (US); Lucette FALCON, Sugar Land, TX (US); Rudolf MATOUSEK, Richmond, TX (US)

(21) Appl. No.: 17/288,069

(22) PCT Filed: Oct. 25, 2019
(86) PCT No.: PCT/US2019/057982

§ 371 Date: Apr. 23, 2021

Related U.S. Application Data
(60) Provisional application No. 62/750,598, filed on Oct. 25, 2018.

(51) Int. Cl. C25B 1/26; C25B 9/17; C25B 15/02

(52) U.S. Cl. CPC C25B 1/26; C25B 15/02; C25B 9/17

(57) ABSTRACT

Provided are systems and methods for controlling the production of chlorate in electrolytic cells. The methods can produce a hypochlorite-containing solution having a chlorate to free available chlorine ratio of less than 0.1 by contacting a flow of a chloride-containing brine to an aqueous feed stream so as to give rise to an admixture. The disclosed technology also includes modulating at least one of the flow rate of the chloride-containing brine and the chloride concentration of the chloride-containing brine so as produce the hypochlorite-containing product solution.

### CROSS REFERENCE TO RELATED APPLICATIONS

The present application claims priority to and the benefit of U.S. Patent Application No. 62/750,598, “Electrolysis Method” (filed Oct. 25, 2018), the entirety of which application is incorporated herein for any and all purposes.

### TECHNICAL FIELD

The present disclosure relates to the field of electrolysis methods for producing hypochlorite-containing solutions using a continuous electrolysis flow cell.

### BACKGROUND

Chlorate (ClO₃⁻) is a common water contaminant that can be harmful to the environment, and to human and animal health. Chlorate is primarily introduced into water as an undesirable by-product of water chlorination processes which are used to disinfect water, in particular drinking water. In addition to potable water suppliers, the food and beverage industry, as well as agricultural users, employ chlorination processes to and disinfect water. As a result, these industries are also sensitive to the presence of chlorate.

Many regulatory agencies, including the United States Environmental Protection Agency (US EPA), are proposing stricter regulations that will limit the amount of chlorate which can be present in drinking water. At present, the World Health Organization has a provisional guideline of 700 parts per billion of chlorate in drinking water, and the US EPA has a Health Reference Level of 210 parts per billion. As a result, municipal water authorities as well as water managers in impacted industries are developing approaches to reduce the introduction of chlorate into water supplies.

Chlorination processes disinfect water by the introduction of hypochlorite-containing solutions into the water being treated. Typically, hypochlorite-containing solutions include chemical species such as hypochlorous acid (HOCl), hypochlorite (ClO⁻) ions, molecular chlorine (Cl₂), and mixtures thereof. Such solutions are known to have wide spectrum anti-bacterial and anti-microbial properties.

Three methods of chlorination are commonly used to produce hypochlorite-containing solutions. Firstly, bulk sodium hypochlorite (e.g. bleach) can be added (e.g. diluted) directly into water. This can be accomplished by dosing small amounts of a concentrated sodium hypochlorite solution into the water to be treated.

Secondly, chlorine gas can be diffused directly into the water to be treated, typically resulting in the production of both hypochlorous acid and hypochlorite ions. Third, hypochlorite-containing solutions can be produced electrolytically by electrolysis systems, such as continuous electrolysis systems, such as on-site generation (OSG) systems or on-site sodium hypochlorite generation (OSHG) systems.

Electrolytic production of hypochlorite-containing solutions typically involves the electrolysis of chloride (Cl⁻) containing solutions (e.g., NaCl brines). During electrolysis Cl⁻ oxidizes to Cl₂ (Equation (1)) and goes on to react with water to produce hypochlorous acid (HOCl) (Equation (2)), which can further convert into hypochlorite ions in the water being treated (depending on the pH of the water being treated):

2Cl⁻→Cl₂+2e⁻ Equation (1)

Cl₂+H₂O→HOCl+HCl Equation (2)

However, when either bulk sodium hypochlorite or sodium hypochlorite produced through electrolysis is used to disinfect water, undesirable chlorate ions can also be produced via a number of chemical and electrochemical mechanisms.

When bulk hypochlorite is used, the primary mechanism by which chlorate is formed is by the disproportionation of hypochlorite. In this process, hypochlorite ions (ClO⁻) are converted into chlorate ions (ClO₃⁻) and chloride ions according to Equation (3):

3ClO⁻→ClO₃⁻+2Cl⁻ Equation(3)

At lower pH values, when both hypochlorite ions (ClO⁻) and hypochlorous acid (HOCl) are present in solution, a reaction can occur between hypochlorous acid and hypochlorite ions to produce chlorate ions according to Equation (4):

2HOCl+ClO⁻→ClO₃⁻+2Cl⁻+2H⁺ Equation (4)

When electrolytic systems are used to electrolyze solutions comprising chloride ions, a number of electrochemical pathways result in the undesirable production of chlorate ions. Equations (5) and (6) show how hypochlorite or hypochlorous acid can be oxidized in the presence of water to produce chlorate ions, while Equation (7) shows a reaction pathway whereby chloride ions can be directly oxidized to chlorate ions in the presence of water.

6ClO⁻+3H₂O→3/2O₂+2ClO₃⁻+4Cl⁻+6H⁺+6e⁻ Equation (5)

6HOCl+3H₂O→3/2O₂+2ClO₃⁻+4Cl⁻+12H⁺+6e⁻ Equation (6)

Cl⁻+3H₂O→ClO₃⁻+6H⁺+6e⁻ Equation (7)

Continuous electrolytic systems offer a number of benefits over the addition of bulk hypochlorite and the diffusion of chlorine gas for the chlorination of water. Continuous electrolytic systems allow the “on-demand” production of hypochlorite-containing solutions from inexpensive, readily available chloride-containing feed stocks (e.g. NaCl). Consequently, continuous electrolytic systems do not require the transportation, storage and handling of harmful and corrosive solutions of concentrated sodium hypochlorite, oxidizing solids such as calcium hypochlorite (Ca(OCl)₂), or toxic gases such as chlorine (Cl₂), offering significant environmental, health, and safety benefits.

On-site generation systems are a type of continuous electrolytic system which allow for “on demand” formation of hypochlorite-containing solutions. On-site generation systems produce hypochlorite-containing solutions by electrolysis of chloride-containing solutions and are configured to dose the hypochlorite-containing solutions into a second water source to disinfect the second water source. For example, on-site generation systems can be used to dose hypochlorite-containing solutions into a flow of water (e.g. “in-line” dosing), or into a (storage) reservoir of water.

However, a recent study (Stanford et. al., Chlorate, perchlorate, and bromate in on-site generated hypochlorite systems, Journal American Water Works Association, 2013, 105, pp. E93-E102) has shown that there is no apparent correlation between the operating conditions used in electrolytic on-site generation systems and the amount of chlorate produced. Thus, despite the efforts of those in the field, there is a long-felt need for the development of new electrolytic methods for the generation of hypochlorite-containing solutions in which the chlorate levels can be controlled.

### SUMMARY

In meeting the described long-felt needs, the present disclosure provides a method for reducing the chlorate concentration in waters treated with hypochlorite produced using a continuous electrolytic system.

In one non-limiting aspect, the present disclosure provides a method for producing a hypochlorite-containing solution with a chlorate to free available chlorine ratio of less than 0.1, comprising the steps of (a) providing a chloride-containing feed having a chloride concentration of at least 40 mmol/L (e.g., from 40 mmol/L to 5000 mmol/L); and (b) passing the chloride-containing feed through a continuous electrolysis cell operating at an electrolysis plate-to-plate voltage of less than or equal to 10 volts, and preferably less than 8 volts, to form the hypochlorite-containing solution.

The electrolysis plate-to-plate voltage can be, e.g., less than or equal to 8 volts, more preferably the electrolysis plate-to-plate voltage is less than or equal to 7 volts, most preferably the electrolysis plate-to-plate voltage is less than or equal to 6 volts. In some embodiments, the plate-to-plate voltage is from about 3.5 to about 4 volts.

In another aspect, the present disclosure provides methods for producing a hypochlorite-containing product solution with a chlorate to free available chlorine (FAC) ratio of from about 0.005 to about 0.1, comprising: contacting a flow of a chloride-containing brine to an aqueous feed stream so as to give rise to an admixture, the flow having a flow rate, the chloride-containing brine having a chloride concentration, and the chloride concentration of the admixture and/or the chloride-containing brine optionally being in the range of from about 200 to about 2500 mmol/L; passing the admixture through a continuous electrolysis cell so as to give rise to the hypochlorite-containing product solution; and modulating at least one of the flow rate of the chloride-containing brine and the chloride concentration of the chloride-containing brine so as produce the hypochlorite-containing product solution with a chlorate to FAC ratio of from about 0.005 to about 0.1.

Also provided are methods, comprising: contacting a flow of a chloride-containing brine to an aqueous feed stream so as to form an admixture, the chloride-containing brine having therein a concentration of chloride; passing the admixture through a continuous electrolysis cell so as to give rise to a hypochlorite-containing product solution, the continuous electrolysis cell optionally (i) operating at an essentially constant plate-to-plate voltage therein, or (ii) operating at an essentially constant current therein; identifying a characteristic of the flow rate of the chloride-containing brine that gives rise to the hypochlorite-containing product solution having a chlorate to FAC ratio of from about 0.005 to about 0.1.

Also disclosed are systems, comprising: an electrolysis cell configured to be in fluid communication with a chloride-containing brine and an aqueous feed, the electrolysis cell being configured to output (e.g., from electrolysis of an admixture that comprises the chloride-containing brine and the aqueous feed) a hypochlorite-containing product solution having a chlorate to FAC ratio of from about 0.005 to about 0.1, the system being configured to modulate at least one of the flow rate of the chloride-containing brine and the chloride concentration of the chloride-containing brine so as produce the hypochlorite-containing product solution with a chlorate to FAC ratio of from about 0.005 to about 0.1, the system optionally being configured to (i) modulate at least one of the flow rate of the chloride-containing brine and the chloride concentration of the chloride-containing brine (which can, in turn, affect the chloride concentration in the admixture that is electrolyzed) so as to maintain an essentially constant plate-to-plate voltage within the continuous electrolysis cell, (ii) modulating at least one of the flow rate of the chloride-containing brine and the chloride concentration of the chloride-containing brine so as to maintain an essentially constant current supplied within the continuous electrolysis cell, or (i) and (ii).

The present inventors have surprisingly found that when the voltage of the electrolysis cell and chloride concentration of the chloride-containing brine are controlled according to the present disclosure, hypochlorite-containing solutions with surprisingly low chlorate to free available chlorine ratios can be obtained.

### BRIEF DESCRIPTION OF THE DRAWINGS

In the drawings, which are not necessarily drawn to scale, like numerals may describe similar components in different views. Like numerals having different letter suffixes can represent different instances of similar components. The drawings illustrate generally, by way of example, but not by way of limitation, various aspects discussed in the present document. In the drawings:

FIG. 1 provides an exemplary embodiment of an apparatus suitable for carrying out the method of the present disclosure;

FIG. 2 provides another exemplary embodiment of an apparatus suitable for carrying out the method of the present disclosure; and

FIG. 3 provides a further exemplary embodiment of an apparatus suitable for carrying out the method of the present disclosure.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the claimed technology.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps can be performed in any order.

It is to be appreciated that certain features of the invention which are, for clarity, described herein in the context of separate embodiments, can also be provided in combination in a single embodiment. Conversely, various features of the invention that are, for brevity, described in the context of a single embodiment, can also be provided separately or in any subcombination. All documents cited herein are incorporated herein in their entireties for any and all purposes.

Further, reference to values stated in ranges include each and every value within that range. In addition, the term “comprising” should be understood as having its standard, open-ended meaning, but also as encompassing “consisting” as well. For example, a device that comprises Part A and Part B can include parts in addition to Part A and Part B, but can also be formed only from Part A and Part B.

Preferred and/or optional features of the invention will now be set out. Any aspect of the invention can be combined with any other aspect of the invention unless the context demands otherwise. Any of the preferred and/or optional features of any aspect can be combined, either singly or in combination, with any aspect of the invention unless the context demands otherwise.

In some aspects, the present disclosure relates to a method for producing a hypochlorite-containing solution, e.g., such a solution with a chlorate to free available chlorine ratio of less than 0.1.

The term “free available chlorine” will be understood to mean the total combined concentration of: hypochlorite ions (ClO⁻), hypochlorous acid (HOCl), and molecular chlorine (Cl₂).

Free available chlorine can be determined by methods known to the person skilled in the art, for example by spectrophotometric determination using N,N-diethylparaphenylenediamine.

For the avoidance of doubt, terms such as “chlorate concentration”, “hypochlorite concentration”, and “chloride concentration” include the concentration of free ions, salts, and conjugate acids. For example, the term “hypochlorite concentration” will be understood to include the concentration of salts of hypochlorite (e.g. NaOCl, KOCl etc.), hypochlorous acid (HOCl), and hypochlorite ions (ClO⁻) and the term “chlorate concentration” will be understood to include salts of chlorate (e.g. NaClO₃, KClO₃, Ca(ClO₃)₂ etc.), chloric acid (HClO₃), and chlorate ions (ClO₃⁻).

As used herein, the chlorate to free available chlorine (FAC) ratio refers to the chlorate concentration in mg/L divided by the free available chlorine concentration in mg/L.

Chlorate concentration can be determined by methods known to the person skilled in the art, for example by ion chromatographic analysis.

The present disclosure provides, inter alia, a method for electrolyzing chloride-containing feeds to produce hypochlorite-containing solutions with a chlorate to free available chlorine ratio (FAC) of less than 0.1.

Preferably the chlorate to free available chlorine ratio can be less than 0.075, less than 0.05, less than 0.025, less than 0.02, less than 0.015, or less than 0.01.

The present disclosure comprises the step of providing a chloride-containing feed with a chloride concentration of at least 40 mmol/L.

The chloride-containing feed can have a chloride concentration of at least 100 mmol/L, at least 200 mmol/L, at least 250 mmol/L, at least 500 mmol/L, at least 1000 mmol/L, at least 1500 mmol/L, or at least 2000 mmol/L. The chloride-containing feed can have a chloride concentration of less than 5000 mmol/L, less than 4000 mmol/L, less than 3000 mmol/L, or less than 2500 mmol/L.

Typically, the chloride-containing feed can have a chloride concentration in the range of 100 to 2000 mmol/L, 200 to 2000 mmol/L, 500 to 2000 mmol/L, 1000 to 2000 mmol/L, or 1500 to 2000 mmol/L.

The chloride-containing feed can be prepared by dissolving a chloride-containing compound in water; the chloride-containing feed can also be prepared by admixing a source brine with an aqueous feed. The chloride-containing compound used to prepare the chloride-containing feed is not particularly limited. Preferably the chloride-containing compound used to prepare the chloride-containing feed is sodium chloride (NaCl). The person skilled in the art will be aware of alternative chloride-containing compounds suitable for producing the chloride-containing solution.

The method according to the present disclosure further comprises the step of passing the chloride-containing feed through a continuous electrolysis cell wherein an electrolysis plate-to-plate voltage of less than or equal to 12 volts is applied.

The continuous electrolysis cell comprises two or more electrodes separated by a fluid path. The two or more electrodes can independently be an anode and a cathode. The electrolysis cell can further comprise one or more intermediate electrode(s). The number of intermediate electrodes used in the electrolysis cell is not particularly limited, for example, the electrolysis cell can comprise two or more intermediate electrodes, three or more intermediate electrodes, four or more intermediate electrodes, or a plurality of intermediate electrodes. The intermediate electrode can be a bipolar electrode.

The electrolysis cell can comprise an anode and a cathode. The electrolysis cell can comprise an anode, a cathode, and one or more intermediate electrode(s).

The continuous electrolysis cell comprises an inlet and an outlet which form part of the fluid path. The inlet and outlet are in fluid communication with one another and allow solutions (e.g. the chloride-containing feed) to pass continuously through the electrolysis cell.

As solution passes through the fluid path of the electrolysis cell it passes between two electrodes (e.g. the anode and the cathode) wherein the electrolysis plate-to-plate voltage is applied.

As used herein, the term “plate-to-plate voltage” means the voltage across any two electrodes within the electrolysis cell. For example, in an electrolysis cell containing an anode and a cathode the plate-to-plate voltage will be the voltage between the anode and the cathode. For example, in an electrolysis cell containing an anode, a cathode, and an intermediate electrode, the plate-to-plate voltage will be the voltage between the anode and the intermediate electrode, and the voltage between the intermediate electrode and the cathode. The person skilled in the art will know how to configure an electrolysis cell to achieve plate-to-plate voltages required by the present disclosure.

The electrolysis plate-to-plate voltage can be less than or equal to 12 volts, less than or equal to 8 volts, less than or equal to 7 volts, less than or equal to 6 volts, less than or equal to 5.5 volts, or less than or equal to 5 volts.

The electrolysis plate-to-plate voltage can be greater than or equal to 2 volts, greater than or equal to 3 volts, or greater than or equal to 4 volts.

The electrolysis plate-to-plate voltage can be in the range of about 2 to about 8 volts, about 3 to about 7 volts, about 4 to about 7 volts, about 4.5 to about 6 volts, about 5 to about 6 volts.

An electrolysis cell forms part of an electrolytic system, e.g., a continuous system. It will be understood that a continuous system is not a batch system. A continuous system will be understood to be a system configured so that the chloride-containing solution feed passes only once through the electrolysis cell.

Conversely, a batch system will be understood to include systems where electrolysis is carried out on a bulk chloride-containing solution (e.g., as a feed) in a single vessel or container. In a batch system the chloride-containing solution feed can be subjected to electrolysis multiple times. For example, a batch system includes electrolysis in a single vessel where the chloride-containing solution feed is not removed from the single vessel during electrolysis and can be electrolyzed multiple times. A batch system will also include a closed system configured such that following electrolysis of a chloride-containing solution feed the resulting hypochlorite-containing solution is recirculated through the electrolysis cell (i.e. the hypochlorite-containing solution can be subjected to electrolysis a second, or subsequent, time).

Following electrolysis of the chloride-containing solutions feed, a hypochlorite-containing solution is produced. The hypochlorite concentration can be greater than 500 mg/L, greater than 1000 mg/L, greater than 2000 mg/L, greater that 3000 mg/L, greater than 5000 mg/L, or greater than 7000 mg/L. Typically, the chloride-containing feed is electrolyzed in the electrolysis cell for an average electrolysis residence time of, e.g., between 30 seconds and 600 seconds. Under one embodiment the average electrolysis residence time can be greater than 30 seconds, greater than 35 seconds, greater than 40 seconds, or greater than 45 seconds.

Under a further embodiment the average electrolysis residence time can be less than 120 seconds, less than 110 seconds, or less than 100 seconds. Under a yet further embodiment, the residence time in the electrolysis cell can be between 260 seconds and 600 seconds, between 250 seconds and 590 seconds, between 240 seconds and 580 seconds.

In certain embodiments of the present disclosure the electrolysis cell is used in an on-site generation system. The method of the present disclosure for producing hypochlorite-containing solution is particularly applicable and beneficial to use in an on-site generation system.

In certain embodiments of the present disclosure the electrolysis cell comprises a control system and one or more sensors on the inlet and the outlet of the electrolysis cell.

The sensors can be used to detect, without limitation, one or more of: (i) the chloride concentrations in the chloride-containing feed being supplied to the electrolysis cell; (ii) the hypochlorite concentration of the solution exiting the electrolysis cell; (iii) the chlorate concentration of the hypochlorite solution exiting the cell; (iv) the temperature of the chloride-containing feed or hypochlorite-containing solution; (v) the flowrate of the chloride-containing feed entering the cell. A sensor can also be used to detect the concentration of chloride in a flow that is contacted to the feed, e.g., the concentration of chloride in a brine that is added to an aqueous flow so as to make up the chloride-containing feed that is supplied to the electrolysis cell.

The sensors communicate with the control system. The control system can be used to affect changes to any condition (e.g. applied plate-to-plate voltage, flow rate, chloride concentration in the chloride-containing solution etc.) used in the method of the present disclosure. Manipulation of the conditions under which electrolysis is carried out can be desirable if, for example, the chlorate concentration of the solution exiting the electrolysis cell is higher than desired.

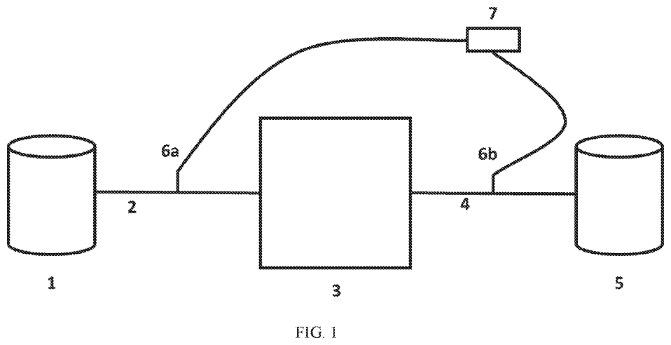

FIG. 1 shows an embodiment of an electrolysis system. In this embodiment chloride-containing solution, such as a sodium chloride solution, is prepared in vessel 1 and is passed along inlet 2 to a continuous electrolysis cell 3. The electrolysis plate-to-plate voltage is applied to the solution in the electrolysis cell before the resulting hypochlorite-containing solution exits the cell along the outlet 4. The hypochlorite-containing solution is then collected in vessel 5. Sensors (6a and 6b) are placed on the inlet (2) and outlet (4), which sensors feed data back to the control system (7). The control system (7) can then vary conditions according to the present disclosure to produce a hypochlorite-containing solution with the required chlorate to free available chlorine (FAC) ratio.

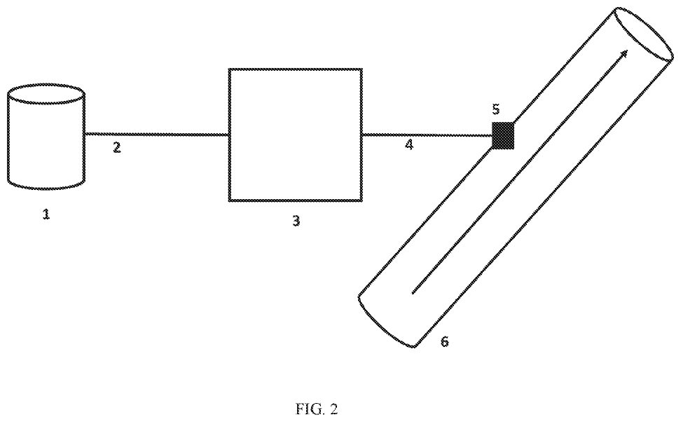

FIG. 2 shows an embodiment of an on-site generation system. A chloride-containing solution (e.g., the feed) is prepared in vessel 1 and is passed along inlet 2 to the electrolysis cell 3. The electrolysis plate-to-plate voltage is applied to the solution in the electrolysis cell before the resulting hypochlorite-containing solution exits the cell along the outlet 4. The hypochlorite-containing solution is then dosed by a dosing device (5) into a continuous flow of secondary water in a pipe (6).

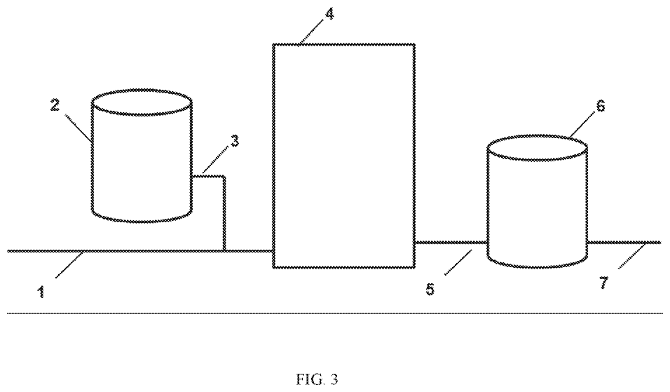

FIG. 3 shows an additional embodiment of an on-site generation system. Here, water is brought into the system through line 1. Saturated chloride-containing brine is prepared in vessel 2 and is transferred along line 3 to combine with the contents of line 1 so as to give rise to an admixture that is then fed into electrolysis system 4. Vessel 2 can be a tank or other container, and can be configured to receive additional salt and/or solvent (e.g., water) before, during, or even after system operation.

Not shown in this figure are specific components of electrolysis system 4 that will be understood by those skilled in the art to comprise said system, including the electrolytic cell, electrical power supplies, various pumps, and control systems. Moreover, it is understood that not all of these components need to be contained in a single structure in order to practice the present disclosure.

Once electrolysis of the diluted brine is complete, the electrolyzed solution will leave electrolysis system 4 along line 5 to vessel 6, where the solution is temporarily stored. (It should be understood that vessel 6 is optional.) When needed, the electrolyzed solution is transported out of vessel 6 via line 7 through the application of mechanisms not specifically shown here to the point of application.

As one non-limiting example referencing FIG. 3, one can form an admixture by contacting aqueous feed 1 with a flow of a chloride-containing brine (or “source brine”) 3, which chloride-containing brine is supplied by element 2. (Element 2 can be, e.g., a vessel, a tank, or a brine generator). The chloride-containing brine can be, e.g., a saturated NaCl solution, but it can also be a non-saturated NaCl solution, e.g., a solution that is within about 10% of saturation. The chloride level in the source brine can be maintained in a manual fashion, but can also be maintained in an automated fashion as well.

The admixture is then passed through electrolysis system 4, in which electrolysis performed on the admixture gives rise to a hypochlorite-containing product solution 5. Solution 5 can in turn be stored in vessel 6 and can be expressed via line 7 from storage vessel 6.

### EXAMPLES

The following examples are illustrative only and do not serve to limit the scope of the present disclosure or the appended claims.

The disclosed technology will now be described with reference to the following examples, which are provided to assist with understanding the present disclosure and are not intended to limit its scope.

### Example 1

Using a continuous (unseparated) electrolysis cell, chloride-containing solutions (prepared from sodium chloride) at a NaCl concentration of 15 g/L (corresponding to a chloride concentration of 257 mmol/L) were electrolyzed with an applied electrolysis plate-to-plate voltage of between 3 and 6 volts. The electrolysis cell comprised a primary anode, a primary cathode, and a single intermediate electrode. Each electrode had an electrolytically active dimensions of 1″×3″. After these solutions were electrolyzed, the pH and free available chlorine content of the samples was measured using standard laboratory methods. A portion of the electrolyzed solutions were then quenched by the addition of excess malonic acid, and these quenched solutions were then used for the measurement of chlorate in the solution. The results in Table 1 show that increasing the voltage used to electrolyze the chloride-containing solution resulted in an increase in the chlorate to free available chlorine ratio from 0.002 to 0.028.

TABLE 1
Exemplary results.

| | | | | | Chlorate |
|---|---|---|---|---|---|
| Electrolysis | | | Oxidant | Oxidant | to free |
| plate-to- | Cell | | FAC | Chlorate | available |
| plate | Current | Oxidant | Content | Content | chlorine |
| voltage (V) | (A) | pH | (mg/L) | (mg/L) | ratio |
| 3 | 1.64 | 8.46 | 500 | 1.1 | 0.002 |
| 4 | 4.07 | 8.72 | 1025 | 5.8 | 0.006 |
| 5 | 6.76 | 8.86 | 1650 | 27 | 0.016 |
| 6 | 9.62 | 8.99 | 2250 | 62 | 0.028 |

Without being bound to any particular theory, it is believed that at comparatively high current densities, current efficiency is reduced. This reduced efficiency in turn results in a relative increase in the production of chlorate and other inefficiency products.

### Example 2

Using a continuous electrolysis cell, sodium chloride solutions of between 2.5 and 50 g/L NaCl concentrations (corresponding to a chloride concentration of 43 to 1711 mmol/L) were electrolyzed with an electrolysis plate-to-plate voltage of 6 volts. In this example, the electrolysis cell is comprised of a primary anode, a primary cathode, and a single intermediate electrode. Each electrode had an electrolytically active dimensions of 1″×3″. After these solutions were electrolyzed, the Free Available Chlorine (FAC) content of the samples was measured by spectrophotometric determination using N,N-diethylparaphenylenediamine, and the pH was measured. A portion of the electrolyzed solutions were then quenched by the addition of excess malonic acid, and these quenched solutions were then used for the measurement of chlorate in the solution by ion chromatography. As can be seen from the results presented in Table 2, increasing the chloride content of the chloride-containing solution resulted in a decrease in the chlorate to free available chlorine ratio in the electrolyzed solutions from 0.066 to 0.005.

TABLE 2
Exemplary results

| | | | | | | Chlorate |
|---|---|---|---|---|---|---|
| | Electrolysis | | | | Oxidant | to free |
| Chloride | plate-to- | Cell | | Oxidant FAC | Chlorate | available |
| concentration | plate | Current | Oxidant | Concentration | Concentration | chlorine |
| (mmol/L) | voltage (V) | (A) | pH | (mg/L) | (mg/L) | ratio |
| 43 | 6 | 1.99 | 8.38 | 275 | 18 | 0.066 |
| 86 | 6 | 3.36 | 8.62 | 575 | 34 | 0.059 |
| 171 | 6 | 5.95 | 8.84 | 1400 | 64 | 0.046 |
| 257 | 6 | 7.97 | 8.90 | 2075 | 63 | 0.030 |
| 342 | 6 | 10.07 | 8.96 | 2625 | 47 | 0.018 |
| 856 | 6 | 19.80 | 9.05 | 5650 | 43 | 0.008 |
| 1711 | 6 | 22.10 | 8.95 | 7600 | 35 | 0.005 |

This data show that as the chloride concentration is increased the chlorate to free available chlorine ratio decreases. Surprisingly, operating at an electrolysis plate-to-plate voltage of 6 volts or less in combination with a chloride concentration of greater than 40 mmol/L enabled the generation of hypochlorite-containing solutions with very low chlorate to free available chlorine ratios.

### Example 3

Using a continuous electrolysis system (that included two intermediate plates in addition to the primary anode and cathode), sodium chloride solutions of between 5 and 75 g/L NaCl concentrations were electrolyzed with an electrolysis plate-to-plate voltage ranging between 3.0 and 4.6 V with an applied current ranging between 5.1 and 12.7 A. After these solutions were electrolyzed, the Free Available Chlorine (FAC) content of the samples was measured by spectrophotometric determination using N,N-diethylparaphenylenediamine, and the pH was measured. A portion of the electrolyzed solutions were then quenched by the addition of excess malonic acid, and these quenched solutions were then used for the measurement of chlorate in the solution by ion chromatography. As can be seen from the results presented in Table 3, increasing the chloride content of the chloride-containing solution resulted in a decrease in the chlorate to free available chlorine ratio in the electrolyzed solutions from 0.022 to 0.069.

TABLE 3
Exemplary results.

| | | | | | | Chlorate |
|---|---|---|---|---|---|---|
| Sodium | Electrolysis | | | | Oxidant | to free |
| chloride | plate-to- | Cell | | Oxidant FAC | Chlorate | available |
| concentration | plate | Current | Oxidant | Concentration | Concentration | chlorine |
| (g/L) | voltage (V) | (A) | pH | (mg/L) | (mg/L) | ratio |
| 5 | 4.6 | 5.1 | 9.01 | 1600 | 110 | 0.069 |
| 10 | 4.4 | 9.2 | 9.14 | 3125 | 190 | 0.061 |
| 15 | 4.3 | 11.7 | 9.32 | 4900 | 290 | 0.059 |
| 25 | 3.8 | 12.8 | 8.98 | 6650 | 190 | 0.029 |
| 40 | 3.4 | 12.8 | 9.06 | 6600 | 190 | 0.029 |
| 75 | 3.0 | 12.7 | 9.01 | 6700 | 150 | 0.022 |

### Example 4

Using a continuous electrolysis system, sodium chloride solutions of between 15.8 and 31.7 g/L NaCl concentrations were electrolyzed with an electrolysis plate-to-plate voltage ranging between 3.4 and 4.3 V with an applied current of 65-A. After these solutions were electrolyzed, the Free Available Chlorine (FAC) content of the samples was measured by iodometric titration. A portion of the electrolyzed solutions were then stabilized by the addition of excess sodium hydroxide and diluted with distilled water maintaining a pH between pH 11-11.5. These stabilized solutions were then used for the measurement of chlorate ion in the solution by ion chromatography. As can be seen from the results presented in Table 4, increasing the chloride content of the chloride-containing solution resulted in a decrease in the chlorate to free available chlorine ratio in the electrolyzed solutions from 0.005 to 0.039.

TABLE 4
Exemplary results.

| | | | | Chlorate |
|---|---|---|---|---|
| Sodium | Electrolysis | | Oxidant | to free |
| chloride | plate-to- | Oxidant FAC | Chlorate | available |
| concentration | plate | Concentration | Concentration | chlorine |
| (g/L) | voltage (V) | (mg/L) | (mg/L) | ratio |
| 17.5 | 4.3 | 8270 | 319 | 0.039 |
| 15.8 | 4.2 | 8310 | 194 | 0.023 |
| 20.4 | 4.0 | 8720 | 106 | 0.012 |
| 21.7 | 3.8 | 9190 | 75 | 0.008 |
| 23.1 | 3.6 | 9160 | 46 | 0.005 |
| 31.7 | 3.4 | 9150 | 45 | 0.005 |

### Example 5

Using a continuous electrolysis system similar to that shown in FIG. 1, sodium chloride solutions with NaCl concentrations of between 5.8 g/L and 12.9 g/L were electrolyzed by passing the solutions through the electrolytic cell at flow rates of either 1.64 ml/min (Table 5) or 8 ml/min (Table 6). After the NaCl solutions were electrolyzed, the resulting oxidant solutions were characterized by measuring the oxidant FAC content and the oxidant chlorate content. As with the other examples, brines containing higher initial NaCl content produced oxidant solutions with lower chlorate content upon electrolysis.

In non-limiting Table 5 and Table 6 below, Faraday's law is used to calculate chlorine grams per hour=(A)(B)(C)(D)(E), where A=35.45 grams/gm-Eq; B=1 gram Eq/26.8 Amp-hours; C=number of compartments (in this case, 1 compartment); D=operating amps; and E=efficiency. Cell area was 19.35 cm², and flow was 1.64 ml/min.

TABLE 5
Exemplary results.

| | Electrolysis | Cell | | | Chlorate | | |
|---|---|---|---|---|---|---|---|
| Sodium | plate-to- | Current | Oxidant | Oxidant | to free | | |
| chloride | plate | Density | FAC | Chlorate | available | | Current |
| concentration | voltage | (mA/ | Concentration | Concentration | chlorine | FAC | Efficiency |
| (g/L) | (V) | cm²) | (mg/L) | (mg/L) | ratio | mg/hr | (%) |
| 5.8 | 3.39 | 200 | 357 | 231 | 0.65 | 35.13 | 0.69 |
| 9.3 | 2.63 | 165 | 453 | 216 | 0.48 | 44.57 | 1.06 |
| 12.9 | 2.28 | 115 | 425 | 116 | 0.27 | 41.82 | 1.42 |

TABLE 6
Exemplary results.

| | Electrolysis | | | | Chlorate | |
|---|---|---|---|---|---|---|
| Sodium | plate-to- | Cell | Oxidant | Oxidant | to free | |
| chloride | plate | Current | FAC | Chlorate | available | Current |
| concentration | voltage | Density | Concentration | Concentration | chlorine | efficiency |
| (g/L) | (V) | (mA/cm²) | (mg/L) | (mg/L) | ratio | (%) |
| 5.8 | 2.75 | 100 | 47 | 19 | 0.40 | 0.88 |
| 9.3 | 3.63 | 200 | 58 | 15 | 0.26 | 0.54 |
| 12.9 | 2.51 | 150 | 129 | 22 | 0.17 | 1.6 |

### Example 6

Using a continuous flow electrolytic cell similar to that described in FIG. 3, sodium chloride brines with similar brine Total Dissolved Solid (TDS) content were electrolyzed at two different total system flow rates. After the NaCl solutions were electrolyzed, the resulting oxidant solutions were characterized by measuring the oxidant FAC content and the oxidant chlorate content.

TABLE 7
Exemplary results.

| | | | | | | Chlorate |
|---|---|---|---|---|---|---|
| Total | | | | | Oxidant | to free |
| System | | | | Oxidant FAC | Chlorate | available |
| Flow Rate | Brine TDS | Cell Voltage | Cell Current | Content | Content | chlorine |
| (gal/hr) | (ppt) | (V) | (A) | (mg/L) | (mg/L) | ratio |
| 299 ± 2 | 33.4 ± 0.3 | 39.1 ± 0.3 | 989 ± 7 | 5350 ± 170 | 117 ± 3 | 0.022 ± 0.001 |
| 351 ± 3 | 33.8 ± 0.8 | 38.8 ± 0.1 | 998 ± 5 | 4920 ± 40 | 69 ± 3 | 0.014 ± 0.001 |

### EMBODIMENTS

The following embodiments are exemplary only and do not serve the limit the scope of the present disclosure or the appended claims.

Embodiment 1. A method for producing a hypochlorite-containing product solution with a chlorate to free available chlorine (FAC) ratio of from about 0.005 to about 0.1, comprising: contacting a flow of a chloride-containing brine to an aqueous feed stream so as to give rise to an admixture, the flow having a flow rate, the chloride-containing solution having a chloride concentration and the admixture having a chloride concentration, and the chloride concentration of the chloride-containing brine and/or of the chloride concentration of the admixture optionally being in the range of from about 200 to about 2500 mmol/L; passing the admixture through a continuous electrolysis cell so as to give rise to the hypochlorite-containing product solution; and modulating at least one of the flow rate of the chloride-containing brine and the chloride concentration of the chloride-containing brine so as produce the hypochlorite-containing product solution with a chlorate to FAC ratio of from about 0.005 to about 0.1.

As an example, one can modulate the chloride concentration of the chloride-containing solution and/or the admixture so as to maintain the chlorate to FAC ratio in the hypochlorite-containing product solution from about 0.005 to about 0.1, or from about 0.005 to about 0.08, or from about 0.005 to about 0.07, or from about 0.005 to about 0.05, or from about 0.005 to about 0.03, or from about 0.005 to about 0.003, or from about 0.005 to about 0.002, or from about 0.005 to about 0.001. One can modulate the chloride concentration of the chloride-containing solution and/or the admixture so as to maintain the chlorate to FAC ratio in the hypochlorite-containing product solution from about 0.005 to about 0.1, or from about 0.005 to about 0.08, or from about 0.005 to about 0.07, or from about 0.005 to about 0.05, or from about 0.005 to about 0.03, or from about 0.005 to about 0.003, or from about 0.005 to about 0.002, or from about 0.005 to about 0.001.

One can modulate the chloride concentration of the chloride-containing solution and/or the admixture so as to maintain the chlorate to FAC ratio in the hypochlorite-containing product solution from about 0.007 to about 0.05, or from about 0.007 to about 0.03, or from about 0.007 to about 0.02, or even from about 0.007 to about 0.01.

As one example, chloride concentration in the admixture can be modulated by, e.g., effecting an increased or decreased chloride concentration in the brine. This can be accomplished by, e.g., adding more of a chloride source (e.g., NaCl, in pure form or in a concentrate form). Alternatively, one can increase the relative amount of solvent to chloride (e.g., by adding water or other solvent) in the chloride-containing brine and/or the admixture so as to decrease the chloride concentration in the admixture. A chloride-containing solution can comprise, e.g., NaCl and water. Other solvents besides water can also be used.

One can also modulate the flow rate of the flow of the chloride-containing brine (or even of the admixture) in addition to—or instead of—modulating the chloride concentration of the chloride-containing brine and/or of the admixture. This can be accomplished by valves, pumps, and other elements known to those of ordinary skill in the art. Thus, one can modulate either one of or both of the flow rate of the flow of the chloride-containing brine and the chloride concentration of the chloride-containing brine.

The chloride concentration of the chloride-containing brine (which can be termed a “source brine”) and/or the admixture can be, e.g., from about 200 to about 2500 mmol/L, or from about 250 to about 2300 mmol/L, or from about 300 to about 2100 mmol/L, or from about 400 to about 1900 mmol/L, or from about 500 to about 1700 mmol/L, or from about 600 to about 1500 mmol/L, or from about 700 to about 1300 mmol/L, or from about 800 to about 1200 mmol/L, or even from about 900 to about 1100 mmol/L. Admixtures having a chloride concentration of from about 200 to about 2500 mol/L, or from about 250 to about 2300 mmol/L, or from about 300 to about 2100 mmol/L, or from about 400 to about 1900 mmol/L, or from about 500 to about 1700 mmol/L, or from about 600 to about 1500 mmol/L, or from about 700 to about 1300 mmol/L, or from about 800 to about 1200 mmol/L, or even from about 900 to about 1100 mmol/L are all considered suitable. It should be understood, however, that the foregoing concentrations and ranges are exemplary only and are not limiting or required.

The chloride-containing brine can be saturated with chloride (e.g., the chloride-containing brine can be a saturated NaCl solution). The chloride-containing brine can also have a chloride concentration that is less than the saturation concentration, e.g., from about 80% to about 99% of the saturation concentration.

The chloride-containing brine can have a chloride concentration that is maintained within 10%, within 5% or even within about 1% of the saturation concentration. Chloride-containing brine can be supplied via, e.g., a brine generator. An exemplary brine generator is a source of saturated (or nearly-saturated) chloride solution, e.g., NaCl. A brine generator can be operated manually but can also be operated in an automated fashion.

As an example, one can contact an aqueous feed (e.g., process water) with a flow of a chloride-containing solution (or “source brine”). The source brine can be a saturated salt solution (e.g., a saturated NaCl solution), but this is not a requirement, as the source brine can have salt dissolved therein at less than a saturation concentration. The source brine can be provided from a brine generator that is configured to maintain (by manual means or in an automated fashion) a level of chloride in the source brine, although this is not a requirement.

The admixture can then be communicated to a continuous electrolysis cell, where electrolysis is performed so as to give rise to the hypochlorite-containing product solution with a chlorate to FAC ratio of from about 0.005 to about 0.1. The product can then be communicated downstream (e.g., to a process unit), but can also be held (e.g., in a storage tank) until needed.

Embodiment 2. The method according to Embodiment 1, further comprising modulating at least one of the flow rate of the chloride-containing brine and the chloride concentration of the chloride-containing brine so as to (i) maintain an essentially constant electrolysis plate-to-plate voltage within the continuous electrolysis cell, or (ii) maintain an essentially constant current supplied within the continuous electrolysis cell. As an example, one can modulate either one or both of the flow rate of the chloride-containing brine (and/or of the admixture) and the chloride concentration of the chloride-containing brine (and/or of the admixture) so as to maintain an essentially constant electrolysis plate-to-plate voltage within the continuous electrolysis cell. As another example, one can modulate either one or both of the flow rate of the chloride-containing brine and the chloride concentration of the chloride-containing brine so as to maintain an essentially constant current supplied within the continuous electrolysis cell. One can modulate either one or both of the flow rate of the admixture and the chloride concentration of the admixture so as to maintain an essentially constant current supplied within the continuous electrolysis cell.

A continuous electrolysis cell can operate at an essentially constant plate-to-plate voltage therein. A continuous electrolysis cell can operate at an essentially constant current supplied thereto.

Embodiment 3. The method according to any one of Embodiments 1-2, further comprising modulating a current supplied within the continuous electrolysis cell so as to maintain an essentially constant electrolysis plate-to-plate voltage within the continuous electrolysis cell.

Embodiment 4. The method according to any one of Embodiments 1-2, further comprising modulating a plate-to-plate voltage within the continuous electrolysis cell so as to maintain an essentially constant current supplied within the continuous electrolysis cell.

Embodiment 5. The method according to any one of Embodiments 1-4, wherein the hypochlorite-containing solution has a chlorate to FAC ratio of less than 0.075. Exemplary such ratios are, e.g., less than 0.075, less than 0.070, less than 0.065, less than 0.060, less than 0.055, less than 0.050, less than 0.045, less than 0.040, less than 0.035, less than 0.030, less than 0.025, less than 0.020, less than 0.015, less than 0.010, less than 0.009, less than 0.008, less than 0.007, or even less than 0.006.

Embodiment 6. The method according to Embodiment 5, wherein the hypochlorite-containing solution has a chlorate to FAC ratio of less than 0.025. Exemplary such ratios are, e.g., from 0.005 to 0.024, 0.005 to 0.022, 0.006 to 0.020, 0.007 to 0.018, from 0.008 to 0.016, or even from 0.009 to 0.014.

Embodiment 7. The method according to Embodiment 6, wherein the hypochlorite-containing solution has a chlorate to FAC ratio of less than 0.010.

Embodiment 8. The method according to any one of Embodiments 1-7, wherein the chloride-containing brine, the admixture, or both has a chloride concentration of from about 250 to about 2500 mmol/L.

Embodiment 9. The method according to Embodiment 8, wherein the chloride-containing brine, the admixture, or both has a chloride concentration of at least 500 mmol/L, e.g., at least 600 mmol/L, at least 700 mmol/L, at least 800 mmol/L, at least 900 mmol/L, at least 1000 mmol/L, at least 1100 mmol/L, at least 1200 mmol/L, at least 1300 mmol/L, at least 1400 mmol/L, at least 1500 mmol/L, at least 1600 mmol/L, at least 1700 mmol/L, at least 1800 mmol/L, at least 1900 mmol/L, at least 2000 mmol/L, at least 2100 mmol/L, at least 2200 mmol/L, at least 2300 mmol/L, or even at least 2400 mmol/L.

Embodiment 10. The method according to Embodiment 9, wherein the chloride-containing brine, the admixture, or both has a chloride concentration of at least 1000 mmol/L.

Embodiment 11. The method according to Embodiment 10, wherein the chloride-containing brine, the admixture, or both has a chloride concentration of at least 1500 mmol/L.

Embodiment 12. The method according to Embodiment 11, wherein the chloride-containing brine chloride-containing brine, the admixture, or both has a chloride concentration of at least 2000 mmol/L.

Embodiment 13. The method according to any one of Embodiments 1-12, wherein the chloride-containing brine comprises sodium chloride. Other chloride-containing salts can be used, e.g., potassium chloride, lithium chloride, calcium chloride, and other metal chlorides. Sodium chloride is considered particularly suitable, but sodium chloride is exemplary only and is not limiting.

Embodiment 14. The method according to any one of Embodiments 1-13, wherein the continuous electrolysis cell has a plate-to-plate voltage of less than or equal to about 8 volts, less than or equal to about 7 volts, less than or equal to about 6 volts, less than or equal to about 5.5 volts, or less than or equal to about 5 volts.

Embodiment 15. The method according to any one of Embodiments 1-14, wherein the concentration of hypochlorite present in the hypochlorite-containing product solution is from about 500 mg/L to about 10,000 mg/L. The concentration of hypochlorite present in the hypochlorite-containing product solution can be, e.g., from about 500 mg/L to about 10,000 mg/L, or from about 600 mg/L to about 9000 mg/L, or from about 800 mg/L to about 8500 mg/L, or from about 900 mg/L to about 8000 mg/L, or from about 950 mg/L to about 7500 mg/L, or from 1000 mg/L to about 7000 mg/L, or from about 1000 mg/L to about 6500 mg/L, or from about 1500 mg/L to about 6000 mg/L, or from about 1800 mg/L to about 5800 mg/L, or from about 2000 mg/L to about 5400 mg/L, or from about 2200 mg/L to about 5000 mg/L, or from about 2500 mg/L to about 4500 mg/L, or from about 2800 mg/L to about 4200 mg/L, or from about 3000 mg/L to about 3900 mg/L, or from about 3200 mg/L to about 3500 mg/L. The foregoing ranges are exemplary only, and are not limiting of the present disclosure.

Embodiment 16. The method according to any one of Embodiments 1-15, wherein at least one of the chloride-containing brine and the admixture has a pH in the range of from about 6 to about 10. The chloride-containing brine (or admixture) can have a pH of from about 6 to about 10, or from about 6.2 to about 9.8, or from about 6.4 to about 9.6, or from about 6.6 to about 9.4, or from 6.8 to about 9.2, or from about 7 to about 9, or from about 7.2 to about 8.8, or from about 7.4 to about 8.6, or from about 7.6 to about 8.4, or from about 7.8 to about 8.2 or even about 8. A pH of from about 6 to about 8 is considered especially suitable.

Embodiment 17. The method according to any one Embodiments 1-16, wherein the admixture has an average residence time in the electrolysis cell of from about 30 to about 600 seconds. A residence time can be, e.g., from about 10 seconds to about 600 seconds, or from about 15 seconds to about 550 seconds, or from about 20 seconds to about 500 seconds, or from about 25 seconds to about 450 seconds, or from about 30 seconds to about 400 seconds, or from about 40 seconds to about 350 seconds, or from about 45 seconds to about 300 seconds, or from about 50 seconds to about 270 seconds, or from about 60 seconds to about 240 seconds, or from about 80 seconds to about 220 seconds, or from about 100 seconds to about 200 seconds, or from about 120 seconds to about 180 seconds, or from about 140 seconds to about 160 seconds.

Embodiment 18. The method according to any one of Embodiments 1-17, wherein the electrolysis cell comprises an intermediate electrode. An electrolysis cell can include one, two, three, four, or more intermediate electrodes.

Embodiment 19. The method according to any one of Embodiments 1-18, wherein the electrolysis cell is used in an on-site generation system, e.g., an on-site hypochlorite generation system. The electrolysis cell can also be used in a portable system, e.g., a portable hypochlorite generation system.

Embodiment 20. The method according to any one of Embodiments 1-19, wherein the electrolysis cell comprises a control system and comprises one or more sensors on an inlet or outlet of the electrolysis cell. A sensor can be configured to monitor a characteristic of the flow of the chloride-containing brine, e.g., the flow rate of that solution, the chloride concentration of that solution, or both. A sensor can be configured to monitor a characteristic of the flow of the admixture, e.g., the flow rate of that admixture, the chloride concentration of that admixture, or both.

A sensor can also be configured to monitor a characteristic of the hypochlorite-containing product solution. Such characteristics can include, e.g., the hypochlorite concentration of that solution, the FAC concentration of that solution, the flow rate of that solution, and the like.

Embodiment 21. The method according to Embodiment 20, wherein the control system is configured to modulate at least one of the flow rate of the chloride-containing brine, the plate-to-plate voltage within the continuous electrolysis cell, the current supplied within the continuous electrolysis cell, and the chloride concentration of the chloride-containing brine, e.g., in response to a signal collected by the one or more sensors.

The control system can also be configured to modulate at least one of the flow rate of the chloride-containing brine, the plate-to-plate voltage within the continuous electrolysis cell, the current supplied within the continuous electrolysis cell, or the chloride concentration of the chloride-containing brine, in response to a manual or automated input. Such input can be—but need not be—based on a signal collected by one or more sensors.

Embodiment 22. A method, comprising: contacting a flow of a chloride-containing brine to an aqueous feed stream so as to form an admixture, the chloride-containing brine having therein a concentration of chloride, the admixture having therein a concentration of chloride; passing the admixture through a continuous electrolysis cell so as to give rise to a hypochlorite-containing product solution, the continuous electrolysis cell optionally (i) operating at an essentially constant plate-to-plate voltage therein, or (ii) operating at an essentially constant current therein; identifying a characteristic of the flow of the chloride-containing brine that gives rise to the hypochlorite-containing product solution having a chlorate to FAC ratio of from about 0.005 to about 0.1.

Without being bound to any particular theory, use, or application, the forgoing method can be used to, e.g., configure a system before the system is delivered to a user or customer. More specifically, the foregoing method can be used to select and set operating parameters for the system such that the system is configured to achieve the desired characteristics in the product, e.g., the desired chlorate to FAC ratio.

As an example, one can contact a flow of chloride-containing brine (also known as “source brine”) to the aqueous feed stream so as to give rise to an admixture. The admixture is then communicated to the continuous electrolysis cell, where electrolysis is performed so as to give rise to the hypochlorite-containing product solution having a chlorate to FAC ratio of from about 0.005 to about 0.1. One can modulate the flow rate of the source brine in order to arrive at the hypochlorite-containing product solution having the desired FAC ratio.

Embodiment 23. The method of Embodiment 22, wherein the characteristic of the flow of the chloride-containing brine is at least one of (i) a concentration of chloride in the chloride-containing brine, and (ii) a flowrate of the chloride-containing brine. Thus, one can identify a chloride concentration (or even a range of chloride concentrations) that effect production of a hypochlorite-containing product solution having a chlorate to FAC ratio of from about 0.005 to about 0.1.

As an example, one can modulate the chloride concentration of the chloride-containing brine (and/or of the admixture) so as to maintain the chlorate to FAC ratio in the hypochlorite-containing product solution from about 0.005 to about 0.1, or from about 0.005 to about 0.08, or from about 0.005 to about 0.07, or from about 0.005 to about 0.05, or from about 0.005 to about 0.03, or from about 0.005 to about 0.003, or from about 0.005 to about 0.002, or from about 0.005 to about 0.001. One can modulate the chloride concentration of the chloride-containing brine (and/or the admixture) so as to maintain the chlorate to FAC ratio in the hypochlorite-containing product solution from about 0.005 to about 0.1, or from about 0.005 to about 0.08, or from about 0.005 to about 0.07, or from about 0.005 to about 0.05, or from about 0.005 to about 0.03, or from about 0.005 to about 0.003, or from about 0.005 to about 0.002, or from about 0.005 to about 0.001.

One can modulate the chloride concentration of the chloride-containing brine (and/or the admixture) so as to maintain the chlorate to FAC ratio in the hypochlorite-containing product solution from about 0.007 to about 0.05, or from about 0.007 to about 0.03, or from about 0.007 to about 0.02, or even from about 0.007 to about 0.01.

Embodiment 24. The method of any one of Embodiments 22-23, comprising identifying a characteristic of the flow rate of the chloride-containing brine (and/or the admixture) that gives rise to the hypochlorite-containing product solution having a chlorate to FAC ratio of from about 0.005 to about 0.05.

Embodiment 25. The method of Embodiment 24, comprising identifying a characteristic of the flow rate of the chloride-containing brine (and/or the admixture) that gives rise to the hypochlorite-containing product solution having a chlorate to FAC ratio of from about 0.005 to about 0.03.

Embodiment 26. A system, comprising: an electrolysis cell configured to receive an admixture that comprises a flow of chloride-containing brine and an aqueous feed, the flow of chloride-containing brine having a flow rate and a chloride concentration, the electrolysis cell being configured to output a hypochlorite-containing product solution having a chlorate to FAC ratio of from about 0.005 to about 0.1, the system being configured to modulate at least one of a flow rate of the chloride-containing brine and the chloride concentration of the chloride-containing brine so as produce the hypochlorite-containing product solution with a chlorate to FAC ratio of from about 0.005 to about 0.1, the system optionally being configured to (i) modulate at least one of the flow rate of the chloride-containing brine and the chloride concentration of the chloride-containing brine to as to maintain an essentially constant plate-to-plate voltage within the continuous electrolysis cell, (ii) modulate at least one of the flow rate of the chloride-containing brine and the chloride concentration of the chloride-containing brine so as to maintain an essentially constant current supplied within the continuous electrolysis cell, or (i) and (ii).

As described elsewhere herein, the chloride-containing brine can be supplied from, e.g., a tank or a brine generator. The chloride-containing brine can be a saturated solution, e.g., a saturated NaCl solution, although other chloride-containing salts (i.e., besides NaCl) can be used. The chloride-containing brine can also include chloride at a less than saturation concentration, e.g., within about 10% of saturation.

As described herein, a system can be configured to modulate either or both of the flow rate of the chloride-containing brine and the chloride concentration of the chloride-containing brine so as produce the hypochlorite-containing product solution with a chlorate to FAC ratio of from about 0.005 to about 0.1. A system can be configured to modulate only the flow rate of the chloride-containing brine. A system can also be configured to modulate only the chloride concentration of the chloride-containing brine.

As an example, one can modulate the chloride concentration of the chloride-containing brine so as to maintain the chlorate to FAC ratio in the hypochlorite-containing product solution from about 0.005 to about 0.1, or from about 0.005 to about 0.08, or from about 0.005 to about 0.07, or from about 0.005 to about 0.05, or from about 0.005 to about 0.03, or from about 0.005 to about 0.003, or from about 0.005 to about 0.002, or from about 0.005 to about 0.001. One can modulate the chloride concentration of the chloride-containing brine so as to maintain the chlorate to FAC ratio in the hypochlorite-containing product solution from about 0.005 to about 0.1, or from about 0.005 to about 0.08, or from about 0.005 to about 0.07, or from about 0.005 to about 0.05, or from about 0.005 to about 0.03, or from about 0.005 to about 0.003, or from about 0.005 to about 0.002, or from about 0.005 to about 0.001. By modulating the chloride concentration (and/or the flow rate) of the chloride-containing brine, the system can modulate the chloride concentration of the admixture.

One can modulate the chloride concentration of the chloride-containing brine so as to maintain the chlorate to FAC ratio in the hypochlorite-containing product solution from about 0.007 to about 0.05, or from about 0.007 to about 0.03, or from about 0.007 to about 0.02, or even from about 0.007 to about 0.01.

Embodiment 27. The system of Embodiment 26, further comprising a sensor train that comprises a sensor configured to monitor one or more characteristics of the hypochlorite-containing product solution. A sensor can be, e.g., a sensor configured to monitor a hypochlorite level in the product solution or e.g., a sensor configured to monitor a chlorate level in the product solution.

Embodiment 28. The system of Embodiment 27, wherein the sensor train comprises a module configured to adjust one or more parameters of the electrolysis cell in response to a signal from the sensor. Such parameters include, without limitation, current, plate-to-plate voltage, and residence time.

Embodiment 29. The system of any one of Embodiments 26-28, wherein the electrolytic cell operates at a plate-to-plate voltage of less than or equal to about 12 volts.

Embodiment 30. The system of Embodiment 29, wherein the electrolytic cell operates at a plate-to-plate voltage of less than or equal to about 10 volts.

Embodiment 31. The system of Embodiment 30, wherein the electrolytic cell operates at a plate-to-plate voltage of about 2 to about 8 volts.

Embodiment 32. The system of any one of Embodiments 26-31, wherein the chloride-containing feed has a chloride concentration of from about 40 mmol/L to about 5000 mmol/L.

Embodiment 33. The system of any one of Embodiments 26-32, wherein the electrolytic cell comprises an anode, a cathode, and optionally one or more intermediate electrodes.

Embodiment 34. The system of any one of Embodiments 26-33, wherein the hypochlorite-containing product solution is characterized by a hypochlorite concentration of greater than about 500 mg/L, e.g., from about 500 mg/L to about 10,000 mg/L.

It should also be understood that a system can include a processor configured to perform one or more operations related to the system's operation. This can be performed based on instructions stored on a transitory or a non-transitory medium. For example, a system can include a processor configured to modulate at least one of the flow rate of the chloride-containing brine and the chloride concentration of the chloride-containing brine so as produce the hypochlorite-containing product solution with a chlorate to FAC ratio of from about 0.005 to about 0.1. A processor can also be configured to modulate the flow rate of the flow of the chloride-containing brine in addition to—or instead of—modulating the chloride concentration of the chloride-containing brine. The processor can be configured to perform the foregoing (or other) steps in response to a signal collected by a component of the system (e.g., a sensor).

1-34. (canceled)

35. A method for producing a hypochlorite-containing product solution with a chlorate to free available chlorine (FAC) ratio of from about 0.005 to about 0.1, comprising:
contacting a flow of a chloride-containing brine to an aqueous feed stream so as to give rise to an admixture,
the flow of chloride-containing brine having a flow rate,
the flow of chloride-containing brine having a chloride concentration,
the admixture having a chloride concentration, and
the chloride concentration of at least one of the chloride-containing brine and of the admixture optionally being in the range of from about 200 to about 2500 mmol/L;
passing the admixture through a continuous electrolysis cell, the continuous electrolysis cell having an anode and a cathode disposed therein and separated by a fluid path such that the admixture passes between the anode and cathode so as to give rise to the hypochlorite-containing product solution; and
modulating at least one of the flow rate of the chloride-containing brine and the chloride concentration of the chloride-containing brine so as produce the hypochlorite-containing product solution with a chlorate to FAC ratio of from about 0.005 to about 0.1.

36. The method according to claim 35, further comprising modulating at least one of the flow rate of the chloride-containing brine and the chloride concentration of the chloride-containing brine so as to (i) maintain an essentially constant electrolysis plate-to-plate voltage within the continuous electrolysis cell, or (ii) maintain an essentially constant current supplied within the continuous electrolysis cell.

37. The method according to claim 35, further comprising modulating a current supplied within the continuous electrolysis cell so as to maintain an essentially constant electrolysis plate-to-plate voltage within the continuous electrolysis cell.

38. The method according to claim 35, further comprising modulating a plate-to-plate voltage within the continuous electrolysis cell so as to maintain an essentially constant current supplied within the continuous electrolysis cell.

39. The method according to claim 35, wherein the hypochlorite-containing solution has a chlorate to FAC ratio of less than 0.075.

40. The method according to claim 35, wherein at least one of the chloride-containing brine and the admixture has a chloride concentration of from about 250 to about 2500 mmol/L.

41. The method according claim 35, wherein the continuous electrolysis cell has a plate-to-plate voltage of less than or equal to about 8 volts, less than or equal to about 7 volts, less than or equal to about 6 volts, less than or equal to about 5.5 volts, or less than or equal to about 5 volts.

42. The method according to claim 35, wherein the concentration of hypochlorite present in the hypochlorite-containing product solution is from about 500 mg/L to about 10,000 mg/L.

43. The method according to claim 35, wherein at least one of the chloride-containing brine and the admixture has a pH in the range of from about 6 to about 10.

44. The method of claim 43, wherein the admixture has a pH of from 7 to 9.

45. The method according to claim 35, wherein the admixture has an average residence time in the electrolysis cell of from about 30 to about 600 seconds.

46. The method according to claim 35, wherein the electrolysis cell comprises an intermediate electrode.

47. The method according to claim 35, wherein the electrolysis cell comprises a control system and comprises one or more sensors on an inlet or outlet of the electrolysis cell, the control system being configured to modulate at least one of the flow rate of the chloride-containing brine, the plate-to-plate voltage within the continuous electrolysis cell, the current supplied within the continuous electrolysis cell, or the chloride concentration of the chloride-containing brine, in response to a signal collected by the one or more sensors.

48. The method of claim 35, wherein the chloride concentration of the admixture is in the range of from about 200 to about 2500 mmol/L.

49. A method, comprising:
contacting a flow of a chloride-containing brine to an aqueous feed stream so as to form an admixture,
the chloride-containing brine having therein a concentration of chloride,
the admixture having therein a concentration of chloride;
passing the admixture through a continuous electrolysis cell, the continuous electrolysis cell having an anode and a cathode disposed therein and separated by a fluid path such that the admixture passes between the anode and cathode so as to give rise to a hypochlorite-containing product solution,
the continuous electrolysis cell optionally (i) operating at an essentially constant plate-to-plate voltage therein, or (ii) operating at an essentially constant current therein; and
identifying a characteristic of the flow rate of the chloride-containing brine that gives rise to the hypochlorite-containing product solution having a chlorate to FAC ratio of from about 0.005 to about 0.1.

50. The method of claim 49, wherein the characteristic of the flow rate of the chloride-containing brine is at least one of (i) a concentration of chloride in the chloride-containing brine, and (ii) a flowrate of the chloride-containing brine.

51. The method of claim 49, wherein the characteristic of the flow rate of the chloride-containing brine is a concentration of chloride in the chloride-containing brine.

52. A system, comprising:
a continuous electrolysis cell configured to receive an admixture that comprises a flow of chloride-containing brine and an aqueous feed,
the continuous electrolysis cell having an anode and a cathode disposed therein such that the admixture passes between the anode and cathode,
the flow of chloride-containing brine having therein a chloride concentration and a flow rate,
the electrolysis cell being configured to output a hypochlorite-containing product solution having a chlorate to FAC ratio of from about 0.005 to about 0.1,
the system being configured to modulate at least one of the flow rate of the chloride-containing brine and the chloride concentration of the chloride-containing brine so as produce the hypochlorite-containing product solution with a chlorate to FAC ratio of from about 0.005 to about 0.1.

53. The system of claim 52, wherein the system is configured to (i) modulate at least one of the flow rate of the chloride-containing brine and the chloride concentration of the chloride-containing brine to as to maintain an essentially constant plate-to-plate voltage within the continuous electrolysis cell, (ii) modulate at least one of the flow rate of the chloride-containing brine and the chloride concentration of the chloride-containing brine so as to maintain an essentially constant current supplied within the continuous electrolysis cell, or (i) and (ii)

54. The system of claim 52, further comprising a sensor train that comprises a sensor configured to monitor one or more characteristics of the hypochlorite-containing product solution.

55. The system of claim 53, wherein the sensor train comprises a module configured to adjust one or more parameters of the electrolysis cell in response to a signal from the sensor.

56. The system of claim 51, wherein the electrolysis cell operates at a plate-to-plate voltage of less than or equal to about 12 volts.

57. The system of claim 51, wherein the electrolytic cell comprises an anode, a cathode, and one or more intermediate electrodes.

58. The system of claim 51, wherein the hypochlorite-containing product solution is characterized by a hypochlorite concentration of greater than about 500 mg/L.

59. The system of claim 53, wherein the system is configured to (i) modulate the flow rate of the chloride-containing brine so as to maintain an essentially constant plate-to-plate voltage within the continuous electrolysis cell, (ii) modulate the flow rate of the chloride-containing brine so as to maintain an essentially constant current supplied within the continuous electrolysis cell, or (i) and (ii).

60. The system of claim 54, wherein the sensor train comprises a module configured to adjust residence time of the electrolysis cell in response to a signal from the sensor.
